(19) United States
(12) Patent Application Publication
(10) Pub. No.: US 2023/0391414 A1
(43) Pub. Date: Dec. 7, 2023

(54) SAFE AND EASY LEARNING BIKE FOR CHILDREN

(71) Applicant: EnSelle, Bailly (FR)

(72) Inventors: Jean-Philippe DUMAS, Bailly (FR); Vincent LALLEMANT, Versailles (FR)

(73) Assignee: EnSelle, Bailly (FR)

(21) Appl. No.: 17/834,304

(22) Filed: Jun. 7, 2022

(51) Int. Cl. B62K 3/02; B62K 19/36

(52) U.S. Cl. CPC B62K 3/02; B62K 19/36

(57) ABSTRACT

A frame including a main tube having a first end and a second end, a head tube connected to the first end, a pedal assembly mechanically connected to the main tube, wherein the pedal assembly forms a pedal circle, and a seat tube connected to the main tube, the seat tube configured to support a saddle, wherein the saddle is configured to slide along the seat tube in a plurality of intermediate positions between a fully retracted position and a fully extended position.

### BACKGROUND

Learning to ride a bicycle is generally considered difficult. Children trying to ride a bicycle without experience generally fall, which may lead to wounds that may be severe. Furthermore, once the child has fallen and/or is wounded, the child's self-confidence may be affected in such a way that they do not want to try to ride a bicycle again. A vicious cycle arises wherein the child does not want to ride a bicycle because they have not learnt how to ride yet, and wherein the child never learns to ride because they do not ride the bicycle.

To solve this problem, some bicycles may be equipped with training wheels. Such training wheels have a smaller size than the size of the bicycle wheels and are arranged laterally on each side of the rear wheel of the bicycle. Such training wheels are intended to prevent the bicycle from falling.

Although such a device allows a child to ride a bicycle while decreasing the chances of falling, this solution is not fully satisfactory because the child does not learn the balance on a bicycle, which is mandatory for progressing further. Indeed, when the child feels confident on the bicycle with training wheels, their parent implements a disassembling step in order to take the training wheels off the bicycle. During this step, the child may lose self-confidence. When the training wheels are taken off, the child is no longer prevented from falling laterally, which may lead to a lack of self-confidence and to the vicious cycle.

Another solution, the dandy horse or push bike, consists of a frame, a front wheel, and a rear wheel. The frame is so designed that the child may sit on a saddle while being able to put both feet flat on the ground or bending their legs. The push bike does not include pedals, the propulsion being implemented by impulsions of the feet of the child directly on the ground.

Such a push bike, also known as a balance bicycle or dandy horse, is quite popular because it allows a child to become familiar with a bicycle-like device. Nevertheless, once the child is familiar with the push bike, they then start using a bicycle. Then, they can no longer put both feet flat on the ground and they start experiencing the above-mentioned vicious cycle.

Accordingly, bikes suited to helping children learn how to ride a bike are needed.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

The present invention relates to the technical field of bicycles and/or pushbikes, in particular to those intended to be used by children. More specifically, the invention aims at allowing a child to learn how to ride a bicycle in a more efficient and less risky manner.

In one aspect, a frame for a bicycle or a dandy horse, the frame including a main tube having a first end and a second end, a head tube connected to the first end, a pedal assembly mechanically connected to the main tube, wherein the pedal assembly forms a pedal circle, and a seat tube connected to the main tube, the seat tube configured to support a saddle, wherein the saddle is configured to slide along the seat tube in a plurality of intermediate positions between a fully retracted position and a fully extended position, wherein the seat tube is so arranged, with respect to the main tube, that, whatever the position of the saddle is between the fully retracted position and the fully extended position, distances x_{z} and x_{b} satisfy a relationship:

x_{z}=B*x_{b}

0.62<B<0.7
wherein x_{z} is the distance between an upper center of gravity of the saddle and a plane surface substantially parallel to the ground surface containing a center of the pedal circle and x_{b} is the distance between the upper center of gravity and the center of the pedal circle is disclosed.

In another aspect, a bicycle including a frame as described herein, a rear wheel mechanically linked to the second end of the main tube, a front wheel mechanically linked to the front fork, and a saddle supported by the seat tube is disclosed.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a perspective view of an example bicycle, in accordance with the present technology;

FIG. 2 is a side view of the bicycle of FIG. 1, in accordance with the present technology;

FIG. 3 is a side view of the bicycle of FIG. 1 with the saddle in a fully extended position, in accordance with the present technology;

FIG. 4 is a detailed view of a rear end of a frame of the bicycle of FIG. 1, in accordance with the present technology;

FIG. 5 is a side view of the rear end of FIG. 4, in accordance with the present technology; and

FIGS. 6A-6D illustrate kinematics of the use of the bicycle of FIG. 1 by a child, in accordance with the present technology.

### DETAILED DESCRIPTION

Described herein is a bicycle for helping a child to learn how to ride a bicycle. In some embodiments, the seat tube may be so arranged, with respect to the main tube, that, whatever the position of the saddle is between the fully retracted position and the fully extended position, distances xₐ and x_{b} satisfy a relationship:

x_{b}=A*xₐ

0.9<A<0.95
wherein xₐ is the distance between an upper center of gravity of the saddle and the ground surface and x_{b} is the distance between the upper center of gravity and a center of the pedal circle.

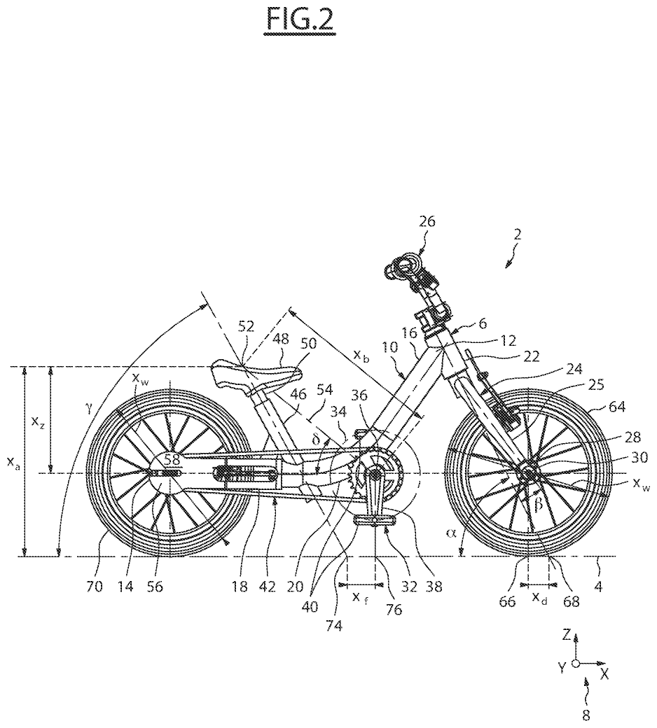

The upper center of gravity 52 (FIG. 2) of the saddle corresponds, according to the present description, to a point of the saddle crossing the general axis of the seat tube of the bicycle or push bike frame.

Additionally, the seat tube may be so arranged, with respect to the main tube, that, whatever the position of the saddle is between the fully retracted position and the fully extended position, distances x_{z} and x_{b} satisfy a relationship:

x_{z}=B*x_{b}

0.62<B<0.7
wherein x_{z} is the distance between an upper center of gravity of the saddle and a plane surface substantially parallel to the ground surface containing a center of the pedal circle and x_{b} is the distance between the upper center of gravity and the center of the pedal circle.

Such an arrangement allows a child user of the frame to decide whether they prefer using it as a push bike or as a bicycle. The child may switch from one use to the other without requiring assistance from another person, such as the intervention of a parent to disassemble and/or re-assemble the frame or pedals. In other words, since the child using the frame is sitting relatively low, he or she can use it as a push bike without being bothered by the pedals when pushing with his or her feet, since the pedals are positioned far away from the legs. Furthermore, the child can also use it as a bicycle, by pedaling easily with a good leg extension.

Therefore, the child using the frame can easily learn to ride a bicycle, as he or she can catch himself at any time if he or she is unbalanced, without falling, switching from the bicycle mode to the push bike mode. Hence, learning to use a bicycle may be implemented much more efficiently.

The seat tube may be so arranged, with respect to the main tube, that, when the saddle in is the fully retracted position, the distances xₐ and x_{b} satisfy a relationship:

x_{b}=C*xₐ

0.9<C<0.91

Preferably, the seat tube is so arranged, with respect to the main tube, that, when the saddle in is the fully retracted position, the distances x_{z} and x_{b} satisfy a relationship:

x_{z}=D*x_{b}

0.62<D<0.63

In another embodiment, the seat tube may be so arranged, with respect to the main tube, that, when the saddle is in the fully extended position, the distances xₐ and x_{b} satisfy a relationship:

xₐ=F*x_{b}

0.94<Γ<0.95

In an embodiment, the seat tube may be so arranged, with respect to the main tube, that, when the saddle is in the fully extended position, the distances x_{z} and x_{b} satisfy a relationship:

x_{z}=E*x_{b}

0.69<E<0.7

In a further embodiment, the seat tube is so arranged, with respect to the main tube, that, whatever the position of the saddle is between the fully retracted position and the fully extended position, a line joining the upper center of gravity and the center of the pedal circle forms an angle, with respect to a portion of the main tube adjacent to the second end, between 39° and 45.5°.

Preferably, the seat tube is so arranged, with respect to the main tube, that, when the saddle is in the fully retracted position, a line joining the upper center of gravity and the center of the pedal circle forms an angle, with respect to a portion of the main tube adjacent to the second end, between 39° and 39.5°.

In another embodiment, the seat tube is so arranged, with respect to the main tube, that, when the saddle is in the fully extended position, a line joining the upper center of gravity and the center of the pedal circle forms an angle, with respect to a portion of the main tube adjacent to the second end, between 45° to 45.5°.

Such arrangements make switching the device between a dandy horse using mode and a bicycle using mode even easier for the child user.

In a further embodiment, a distance x_{f} may lie between 47 mm and 67 mm, wherein the distance x_{f} is the projection, along the direction of a portion of the main tube adjacent to the second end, of a distance between the center of the pedal circle and an intersection between an axis of the seat tube and the ground surface.

Such a distance improves the comfort of the bicycle and/or push bike intended for a child, allowing the child user to switch between the two using modes without being disturbed by the pedals.

In another embodiment, the seat tube may form an angle, with respect to a portion of the main tube adjacent to the second end, between 58° and 61°.

Such a seat tube angle is particularly adapted to allow the child user easily switching between the dandy horse using mode and the bicycle using mode.

Advantageously, the seat tube is so arranged, with respect to the main tube, that the distances x_{c} and xₚ satisfy a relationship:

x_{c}=Δ*xₚ

0.73<Δ<0.8
wherein x_{c} is the distance between the upper center of gravity of the saddle in the fully retracted position and the upper center of gravity of the saddle in the fully extended position, and xₚ is a diameter of the pedal circle.

In a further embodiment, the head tube may form an angle, with respect to a portion of the main tube adjacent to the second end, between 61° and 63.5°.

In some embodiments, the frame further includes a front fork attached to the head tube, a longitudinal direction of a lower portion of the front fork forming an angle, with respect to the head tube, between 9° and 9.5°.

Such angles allow positioning a front wheel, with respect to the frame, in a position wherein it provides a good stability of the bicycle without rendering the bicycle undynamic.

The front fork may be intended to be mechanically pivotably linked to a front wheel around an axis of rotation, said front wheel being intended to be in contact with the ground surface, the head tube and the front fork being so arranged, with respect to the main tube, that a distance x_{d} is strictly higher than 35 mm, and wherein the distance x_{d} is a projection, along the direction of a portion of the main tube adjacent to the second end, of a distance between the axis of rotation and an intersection between an axis of the head tube and the ground surface.

In an embodiment, the distance x_{d} may be strictly within 35 mm and 55 mm.

In some embodiments, the second end of the main tube may include a plate comprising a rectilinear groove extending transversally through the plate and extending, from the second end, into the direction of a portion of the main tube adjacent to the second end.

Such a plate allows enabling the fixation of the wheel to the second end while preventing a child user of the frame from accessing the chain.

Preferably, the dimensions x_{g} and xₚ may satisfy a relationship:

x_{g}=F*xₚ

0.4≤F≤0.5
wherein x_{g} is the length of the rectilinear groove along the direction of the portion of the main tube adjacent to the second end, and xₚ is a diameter of the pedal circle.

In another embodiment, the plate may include a cylindrical surface directed by a direction perpendicular to the plate, the plate being outwardly delimited by the cylindrical surface, the cylindrical surface having a circular cross section.

In an embodiment, the circular cross-section may have a diameter between 80 mm and mm.

Such a design of the plate and of the rectilinear groove allows preventing a child user from accessing the chain using a very low amount of matter, which optimizes the weight of the bicycle and/or of the push bike.

In a further embodiment, the frame may include a saddle supported by the seat tube.

According to another aspect of the invention, a bicycle including a frame as defined above, a rear wheel mechanically linked to the second end of the main tube, a front wheel mechanically linked to the front fork, and a saddle supported by the seat tube is disclosed.

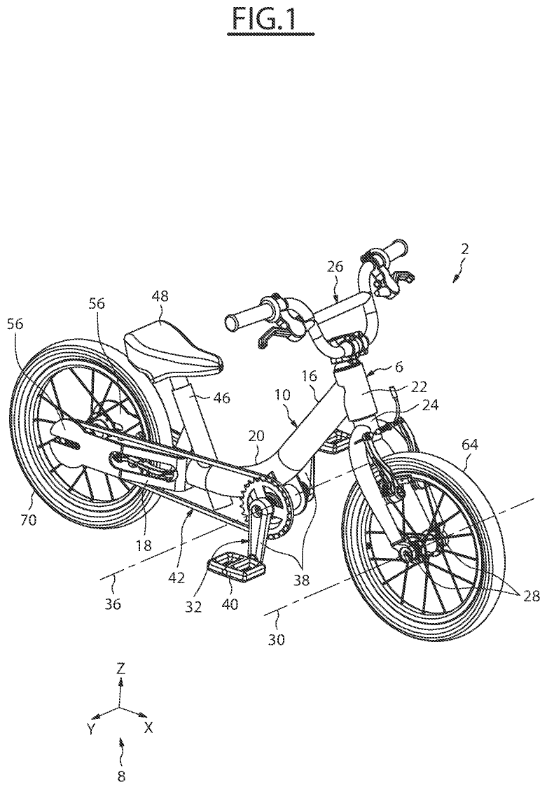

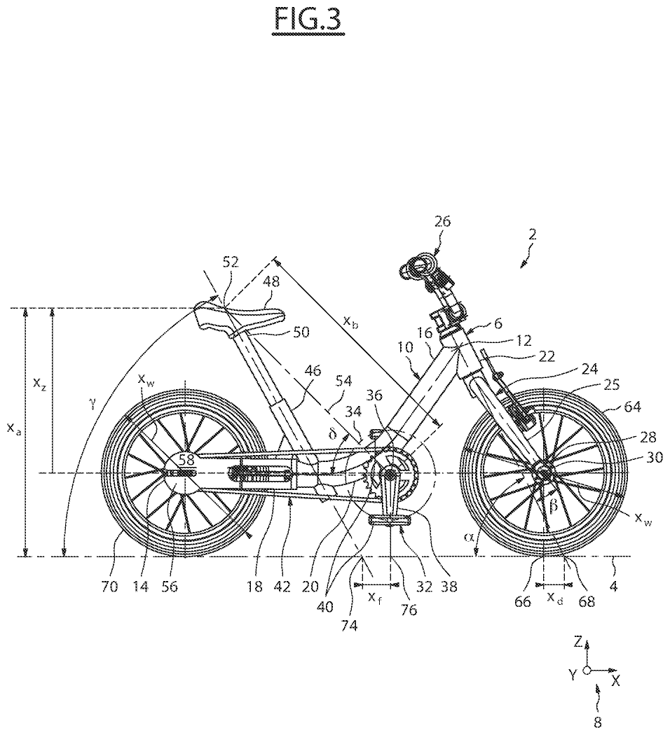

FIG. 1 is a perspective view of an example bicycle 2, in accordance with the present technology. The bicycle 2 aims at resting on a ground surface 4 (see FIGS. 2 and 3). The ground surface 4 is generally plane and substantially horizontal. Nevertheless, the bicycle 2 may rest on another surface, in particular an inclined surface and/or a rounded surface.

The bicycle 2 includes a bicycle frame 6. It is defined an orthonormal direct vector basis 8 attached to the frame 6. The basis 8 consists of a vector X, a vector Y and a vector Z.

In the present application, terms “vertical”, “low”, “down”, “above” and “up” will be understood as referring relative to the basis 8 when the bicycle 2 rests normally on a horizontal flat ground surface, assuming that the vector Z is vertically oriented upwards.

The words “longitudinal”, “front”, “rear”, “transversal”, “left” and “right” will be understood according to the frame 6, assuming that the vector X is longitudinally, frontwards directed and that the vector Y is laterally directed from the left to the right.

The word “cylindrical” will be understood according to its common definition, being namely that a cylindrical surface is a surface consisting of all the points on all the lines which are parallel to a given line and which pass through a fixed plane curve in a plane not parallel to the given line.

FIG. 2 is a side view of the bicycle of FIG. 1, in accordance with the present technology, and FIG. 3 is a side view of the bicycle of FIG. 1 with the saddle in a fully extended position, in accordance with the present technology. Referring now to FIGS. 1 to 3, the bicycle frame 6 includes a main tube 10. The main tube 10 includes a first end 12 (or front end) and a second end 14 (or rear end). The main tube 10 includes a front rectilinear portion 16, a rear rectilinear portion 18 adjacent to the rear end 14, and a central curved portion 20.

The portions 16, 18 and 20 are so designed that the rear portion 18 is substantially horizontal, and that the front portion 16 forms an angle about 74° with respect to the rear portion 18. In some embodiments, the front and rear portions 16 and 18 have approximately the same length.

The frame 6 includes a head tube 22. The head tube 22 is attached to the main tube 10 at its front end 12. The head tube 22 is rectilinear and forms an angle α, with respect to the rear portion 18, within a range 62° to 63.5°.

The bicycle 2 includes a front fork 24 rotatably mounted inside the head tube 22. A lower portion 25 of the front fork 24 forms an angle β, with reference to an axis of the head tube 22, between 9° and 9.5°. The front fork 24 is attached to handlebars 26 to provide steering of the bicycle 2. The portion 25 of the fork 24 includes a pair of mounting ends 28 defining an axis of rotation 30 for a front wheel, as described herein.

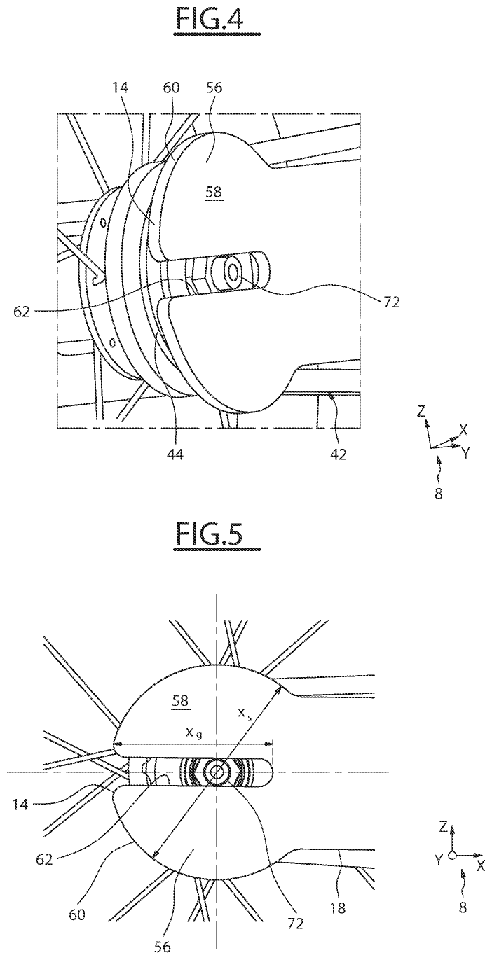

The frame 6 includes a pedal assembly 32. The pedal assembly 32 includes a pedal circle 34 around a center axis 36. The pedal assembly 32 includes a pair of arms 38 running from the center axis 36 into two radial opposite directions, and two pedals 40 pivotably linked to the respective arms 38, at the radial outer end thereof. In a known manner per se, the child user's pressure on the pedals 40 may lead to rotation of the arms 38 around the center axis 36 which is transmitted, by means of a chain assembly 42, to a rear gear assembly 44 (as shown in FIG. 4) for propulsion of the bicycle 2. The pedal circle 34 includes all the positions of the axis of rotation of a pedal 40 relative to the arm 38. The diameter xₚ may be between 150 mm and 160 mm, preferably of 155 mm.

The frame 6 further includes a seat tube 46. The seat tube 46 is attached to the main tube 10, substantially at the junction between the portions 18 and 20. The seat tube 46 is rectilinear and forms an angle γ, with respect to the rear portion 18, between 60° and 61°.

The bicycle 2 includes a saddle 48 including a tubular extension 50 received inside the seat tube 46. By virtue of this arrangement, the saddle 48 is mechanically connected to the frame 6 in such a way that it may slide along the seat tube 46 in a plurality of positions. The saddle 48 is represented in a fully retracted position on FIG. 2, whereas it is represented in a fully extended position in FIG. 3.

Whatever the position of the saddle is between the fully retracted position and the fully extended position, the distance xₐ is defined as the distance between an upper center of gravity 52 and the ground 4, the distance x_{z} is between the upper center of gravity 52 and the rear rectilinear portion 18, and the distance x_{b} is between the upper center of gravity 52 of the saddle 48 and the center axis 36. The upper center of gravity 52 is the vertical projection, on the upper surface of the saddle 48, of the center of gravity of the saddle 48. In other words, the distance x_{z} is the distance between the upper center of gravity 52 of the saddle 48 and a plane surface 58 substantially parallel to the ground surface containing the center 36 of the pedal circle. The plane surface 58 is therefore perpendicular to the vector Y.

Referring to FIG. 2, in the fully retracted position, the distance xₐ is between 370 mm and 380 mm. The distance x_{b} is between 335 mm and 345 mm. The distance x_{z} is between 205 mm and 215 mm.

Referring to FIG. 3, in the fully extended position, the distance xₐ between the upper center of gravity 52 and the ground 4 is between 485 mm and 495 mm. The distance x_{z} is between 320 mm and 330 mm. The distance x_{b} between the upper center of gravity 52 and the axis 36 is between 460 mm and 470 mm.

Referring to FIGS. 2-3, a line 54 is depicted, extending between the upper center of gravity 52 and the center axis 36 and perpendicular to the vector Y. In the fully retracted position, as depicted in FIG. 2, an angle δ between the line 54 and the vector X is between 39° and 39.5°. In the fully extended position, as depicted in FIG. 3, the angle δ is between 45° and Whatever the position of the saddle 48 is between the fully retracted position and the fully extended position, the line 54 forms an angle δ, with respect to the vector X, between 39° and 45.5°.

The distance x_{c} between the upper center of gravity 52 in the fully retracted position and the upper center of gravity 52 in the fully extended position is between 110 mm and 120 mm. Hence, with a diameter xₚ within 150 mm and 160 mm, the distance x_{c} satisfies the relationship:

x_{c}=A*xₚ

0.69<Δ<0.8

The frame 6 includes a pair of plates 56 formed on the portion 18, next to the rear end 14. The plates 56 are substantially plane and perpendicular to the vector Y. More specifically, each plate 56 is laterally delimited by the plane surface 58 perpendicular to the vector Y. Each plate 56 includes a cylindrical surface 60 directed by the direction of the vector Y. The cylindrical surface 60 has a circular axial cross-section, having a diameter xₛ within a range 80 mm to 90 mm. The cylindrical surfaces 60 radially, outwardly delimit the respective plates 56.

Each plate 56 includes a rectilinear groove 62. The rectilinear grooves 62 extend, along the direction of the vector Y, through the respective plates 56. Along the direction of the vector X, the rectilinear grooves 62 extend, from the rear end 14, frontwards in a distance x_{g} between 71 mm and 89 mm.

Referring back to FIGS. 1-3, the bicycle 2 includes a front wheel 64 mounted for rotation, around the axis of rotation 30, with respect to the front fork 24 by means of the mounting ends 28. The front wheel 64 is in point contact with the ground surface 4 at a point 66. The distance x_{d} between the point 66 and a point 68 which is the intersection between the axis of the head tube 22 and the ground surface 4 is between 35 mm and 45 mm.

By virtue of this arrangement, the caster angle of the bicycle 2 is so designed that the bicycle 2 is sufficiently dynamic and has a good stability, adapted to a child who learns riding a bicycle.

FIG. 4 is a detailed view of a rear end of a frame of the bicycle of FIG. 1, in accordance with the present technology. FIG. 5 is a side view of the rear end of FIG. 4, in accordance with the present technology. The bicycle 2 further includes a rear wheel 70 mechanically attached to the rear end 14 of the frame 6. More specifically, the rear wheel 70 includes an axis 72 received inside the grooves 62 of the respective plates 56. By virtue of this arrangement, the rear wheel 70 is able to pivot, around a direction parallel to the vector Y, with respect to the frame 6. The rear wheel 70 is attached to the rear gear assembly 44.

By virtue of the design of the rear end 14, including a plate 56 outwardly delimited by a cylindrical surface of revolution, the child may not access to the rear gear assembly 44. The safety of the child is thus improved.

The diameter x_{w} of the wheels 64 and 70 substantially equals 14 inches, which corresponds to 355 mm.

The distance x_{z} is independent of the diameter x_{w} of wheel 64, contrary to the distance xₐ. Particularly, the distance x_{z} is equal to the distance minus the radius of the rear wheel 64.

Referring back to FIGS. 2-3, a point 74 is the intersection of an axis of the seat tube 46 and the ground surface 4. The point 76 is the vertical projection, on the ground surface 4, of the center axis 36. A distance x_{f} between the points 74 and 76 is between 47 and 67 mm.

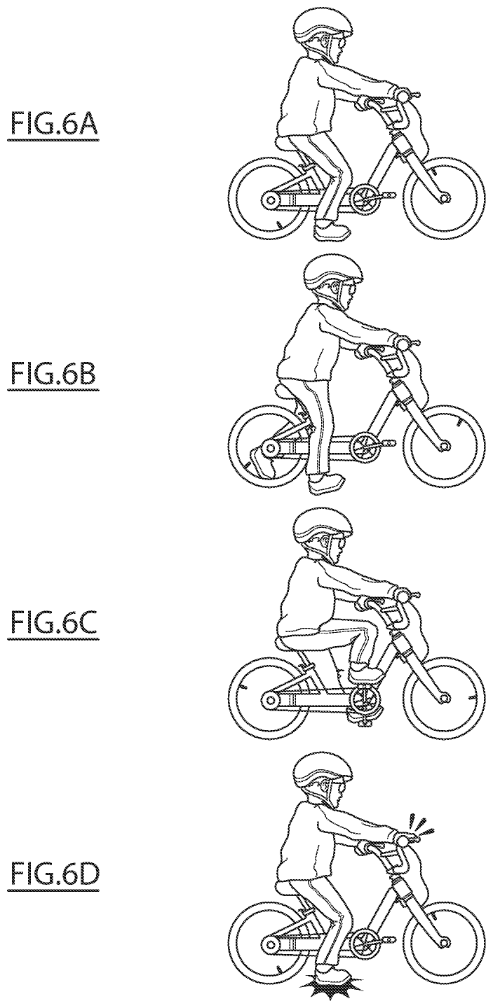

Such a design of the frame 6 allows a child user to use the bicycle 2 in a push bike mode using mode or in a bicycle using mode. FIGS. 6A-6B illustrate kinematics of the use of the bicycle of FIG. 1 by a child, in accordance with the present technology.

In the push bike mode, the child user uses the bicycle 2 without using the pedal assembly 32. For instance, in this using mode illustrated on FIGS. 6A and 6B, the child user can put his two feet flat on the ground surface 4, knees bended, in order to keep the frame 6 vertical and push it forward in an efficient way, without being embarrassed of hurt by the pedal assembly 32. In the bicycle using mode illustrated on FIG. 6C, the child user uses the pedal assembly 32.

To switch between these two using modes, the child only has to stop putting their feet on the ground surface 4 and start putting them on the pedals 40, or vice versa.

Hence, it is provided a device allowing a child user to switch smoothly from a push bike mode into a bicycle mode, and vice versa. If the child user feels confident, they may immediately switch from the dandy horse mode into the bicycle mode, without waiting for the intervention of another person. If, while the child implements the bicycle using mode illustrated on FIG. 6C, the child feels suddenly unsafe of if he is suddenly unbalanced, they may instantly switch into the dandy horse using mode by putting two feet flat on the ground, as illustrated on FIG. 6D, thus avoiding a fall and wounds. The child may thus learn how to ride a bicycle much more efficiently and safely.

While illustrative embodiments have been illustrated and described, it will be appreciated that various changes can be made therein without departing from the spirit and scope of the invention.

The embodiments of the invention in which an exclusive property or privilege is claimed are defined as follows:

1. A frame for a bicycle or a dandy horse, the frame comprising:
a main tube having a first end and a second end;
a head tube connected to the first end;
a pedal assembly mechanically connected to the main tube, wherein the pedal assembly forms a pedal circle; and
a seat tube connected to the main tube, wherein the seat tube is configured to support a saddle, wherein the saddle is configured to slide along the seat tube in a plurality of intermediate positions between a fully retracted position and a fully extended position, wherein the seat tube is so arranged, with respect to the main tube, that, whatever the position of the saddle is between the fully retracted position and the fully extended position, distances x_{z} and x_{b} satisfy a relationship:
x_{z}=B*x_{b}
0.62<B<0.7
wherein x_{z} is the distance between an upper center of gravity of the saddle and a plane surface substantially parallel to the ground surface containing a center of the pedal circle and x_{b} is the distance between the upper center of gravity and the center of the pedal circle.

2. The frame according to claim 1, wherein the seat tube is so arranged, with respect to the main tube, that, when the saddle in is the fully retracted position, the distances x_{z} and x_{b} satisfy a relationship:
x_{z}=D*x_{b}
0.62<D<0.63.

3. The frame according to claim 1, wherein the seat tube is so arranged, with respect to the main tube, that, when the saddle is in the fully extended position, the distances x_{z} and x_{b} satisfy a relationship:
x_{z}=E*x_{b}
0.69<E<0.7.

4. The frame according to claim 1, wherein the seat tube is so arranged, with respect to the main tube, that, whatever the position of the saddle is between the fully retracted position and the fully extended position, a line joining an upper center of gravity and the center of the pedal circle forms an angle, with respect to a portion of the main tube adjacent to the second end, between 39° and 45.5°.

5. The frame according to claim 1, wherein a distance x_{f} is between 47 mm and 67 mm, wherein the distance x_{f} is a projection, along the direction of a portion of the main tube adjacent to the second end of a distance between the center of the pedal circle and an intersection between an axis of the seat tube and the ground surface.

6. The frame according to claim 1, wherein the seat tube forms an angle, with respect to a portion of the main tube adjacent to the second end, between 58° and 61°.

7. The frame according to claim 1, wherein the seat tube is so arranged, with respect to the main tube, that the distances x_{c} and xₚ satisfy a relationship:
x_{c}=Δ*xₚ
0.73<Δ<0.8
wherein x_{c} is the distance between an upper center of gravity of the saddle in the fully retracted position and the upper center of gravity of the saddle in the fully extended position, and xₚ is a diameter of the pedal circle.

8. The frame according to claim 1, wherein the head tube forms an angle, with respect to a portion of the main tube adjacent to the second end, between 61° and 63.5°.

9. The frame according to claim 1, further comprising a front fork attached to the head tube, wherein a longitudinal direction of a lower portion the front fork forms an angle, with respect to the head tube, between 9° and 9.5°.

10. The frame according to claim 9, wherein the front fork is mechanically pivotably linked to a front wheel around an axis of rotation, wherein the front wheel is configured to be in point contact with a ground surface, wherein the head tube and the front fork are arranged, with respect to the main tube, so that a distance x_{d} is higher than 35 mm, and wherein the distance x_{d} is a projection, along the direction of a portion of the main tube adjacent to the second end, of a distance between the axis of rotation and an intersection between an axis of the head tube and the ground surface.

11. The frame according to claim 10, wherein the distance x_{d} is between 35 mm and 55 mm.

12. The frame according to claim 1, wherein the second end of the main tube comprises a plate comprising a rectilinear groove extending transversally through the plate and extending, from the second end, into the direction of a portion of the main tube adjacent to the second end.

13. The frame according to claim 12, wherein the dimensions x_{g} and xₚ satisfy a relationship:
x_{g}=F*xₚ
0.4≤F≤0.5
wherein x_{g} is the length of the rectilinear groove along the direction of the portion of the main tube adjacent to the second end, and xₚ is a diameter of the pedal circle.

14. The frame according to claim 12, wherein the plate further comprises a cylindrical surface directed by a direction perpendicular to the plate, the plate being outwardly delimited by the cylindrical surface, and wherein the cylindrical surface has a circular cross section.

15. The frame according to claim 14, wherein the circular cross section has a diameter between 80 mm and 90 mm.

16. A bicycle comprising a frame according to claim 1, the bicycle further comprising:
a rear wheel mechanically linked to the second end of the main tube;
a front wheel mechanically linked to the front fork; and
a saddle supported by the seat tube.
